(19) United States
(12) Patent Application Publication
(10) Pub. No.: US 2002/0063692 A1
(43) Pub. Date: May 30, 2002

(54) Keyboard device capable of being used as external keyboard device for portable terminal

(75) Inventor: Keiichi Hayashi, Kanagawa (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/995,333

(22) Filed: Nov. 26, 2001

(30) Foreign Application Priority Data
Nov. 27, 2000 (JP) 359963/2000

(51) Int. Cl. G09G 5/00

(52) U.S. Cl. 345/168

(57) ABSTRACT

A keyboard device is provided, which is available even when it is impossible to get sufficient brightness at hand. The keyboard device comprises a key operation section to which a key input is executed, a key backlight in the keyboard configuring the key operation section, a communication control section sending input operation signal operated by a key input, and a photosensor measuring brightness around the keyboard in the act of operating. On the basis of the value of the brightness measured by the photosensor, it is controlled whether the backlight should be turned on or off. By this configuration, it is possible to use the keyboard in the dark and draw up such as e-mail. Further, by turning on and off the key backlight according to the brightness around the keyboard, it is possible to reduce power consumption when the keyboard device is driven by batteries.

### BACKGROUND OF THE INVENTION

The present invention relates to a keyboard device, and in particular, to an external keyboard device for a portable terminal applied to a cellular phone, portable terminal device, personal digital assistance, external keyboard, battery-driven keyboard device and so forth.

Description of the Related Art

Up to now, a keyboard device is generally configured as an external keyboard for a portable terminal instrument. A conventional compact and lightweight keyboard device including a PocketBoard, which is intended for drawing up such as e-mail by connecting with a cellular phone, does not comprise key backlight function.

In the technical field similar to the present invention, for example, there is disclosed “telephone equipment” in Japanese Patent Application Laid-Open No. HEI7-131511. The telephone equipment comprises a surrounding illuminance measuring means that detects surrounding illuminance at the time of pushing a manual operating button. When a detected value does not exceed brightness indicating that it is possible to operate the telephone equipment without trouble, the illumination for buttons and the display unit is controlled so as to be lit up during a definite period of time.

However, as described above, the compact and lightweight conventional keyboard device including a PocketBoard that has already been placed on the market, which is intended for drawing up such as e-mail by connecting with a cellular phone, does not comprise a key backlight function. Thereby, in the case of operating the keyboard device in the dark, it is impossible to recognize characters printed on each key of the keyboard. Further, it is difficult to operate it smoothly.

Besides, even if a backlight for keys is set so as to operate a keyboard device in the dark, when the device is driven by batteries, the power consumption gets high because of the backlight. Thereby, the available time of the keyboard device or the terminal itself is limited.

### SUMMARY OF THE INVENTION

It is therefore an object of the present invention to provide a keyboard device, in particular, to provide an external keyboard for a portable terminal that can be used even if it is impossible to get sufficient brightness at hand.

According to a first aspect of the present invention, for achieving the objects mentioned above, there is provided a keyboard device comprising: a key backlight; and a photosensor, wherein: the photosensor measures brightness around a place where a keyboard is used; and the photosensor controls a lighting operation of the key backlight in accordance with a measured value of the brightness measured by the photosensor.

According to a second aspect of the present invention, the photosensor comprises at least two pieces thereof, and at least one of the photosensors is set in the vicinity of a fingerhold section on the keyboard.

According to a third aspect of the present invention, the keyboard device further comprises a control section controlling operations in the keyboard device.

According to a fourth aspect of the present invention; the keyboard device further comprises: a key operation section; and a communication control section informing that a key is inputted, wherein: the keyboard device is intended for a portable terminal.

According to a fifth aspect of the present invention, the keyboard device further comprises a timer measuring an interval of latency from a last time a key is inputted until a new key is inputted.

According to a sixth aspect of the present invention, the keyboard device further comprises a function state display section indicating that power is in an on-state and that the keyboard device is in an active state.

According to a seventh aspect of the present invention, the lighting operation of the key backlight is controlled on the basis of an average value of measurements by the photosensor.

### BRIEF DESCRIPTION OF THE DRAWINGS

The object and features of the present invention will become more apparent from the consideration of the following detailed description taken in conjunction with the accompanying drawings in which:

FIG. 1 is a block diagram showing a configuration of a keyboard device according to an embodiment of the present invention;

FIG. 2A is a conceptual diagram showing an example of a layout of photosensors;

FIG. 2B is a perspective diagram viewed obliquely from below a keyboard housing showing a section of a photosensor set in the vicinity of the center of the keyboard housing;

FIG. 2C is a perspective diagram viewed obliquely from above the keyboard housing showing the section of the photosensor set in the vicinity of the center of the keyboard housing;

FIG. 3 is a flowchart showing a connection state monitoring operation at the keyboard;

FIG. 4 is a flowchart showing a key input monitoring operation in a connected state at the keyboard;

FIG. 5 is a flowchart showing a key input monitoring operation in the connected state at the keyboard; and

FIG. 6 is flowchart showing an operation of measuring brightness at the keyboard.

### DESCRIPTION OF THE PREFERRED EMBODIMENT

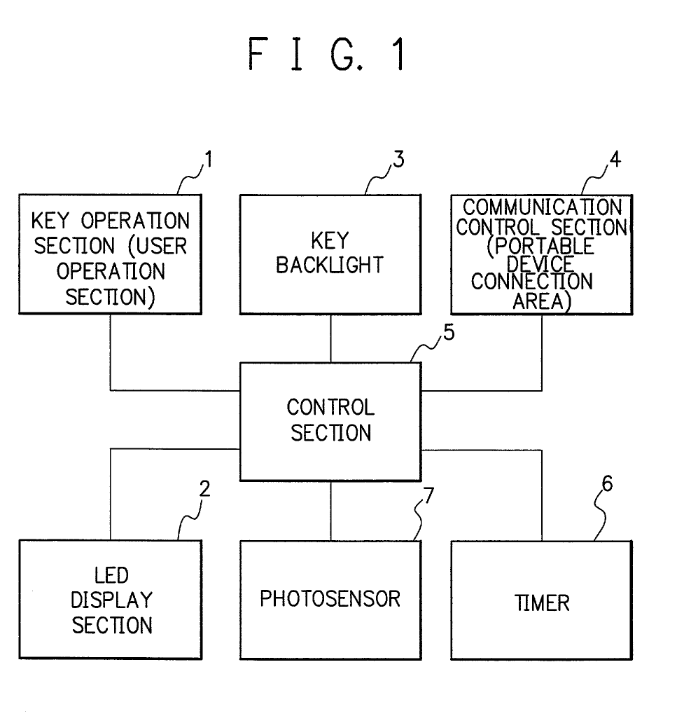

Referring now to FIGS. 1 to 6, an embodiment of the present invention is explained in detail.

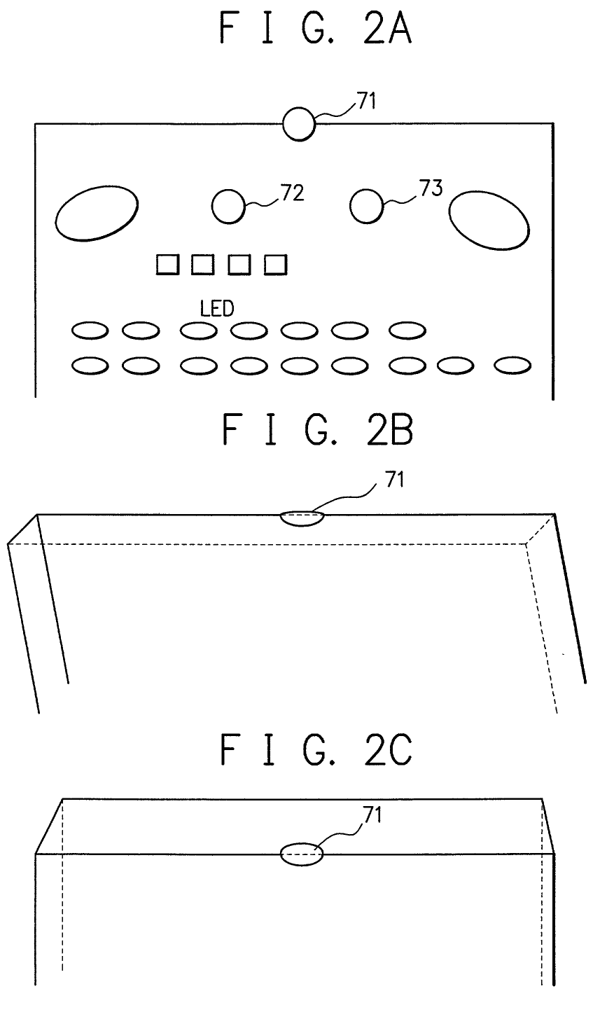

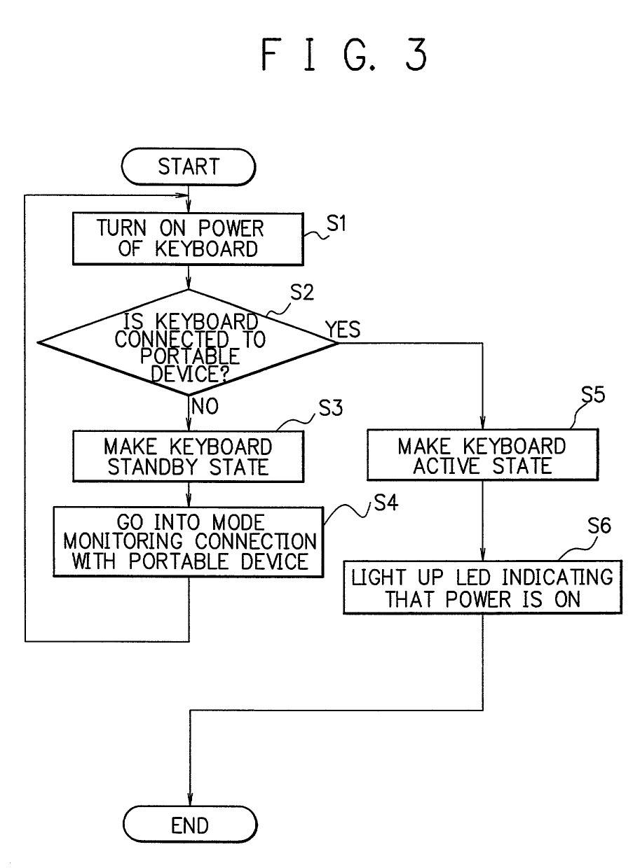

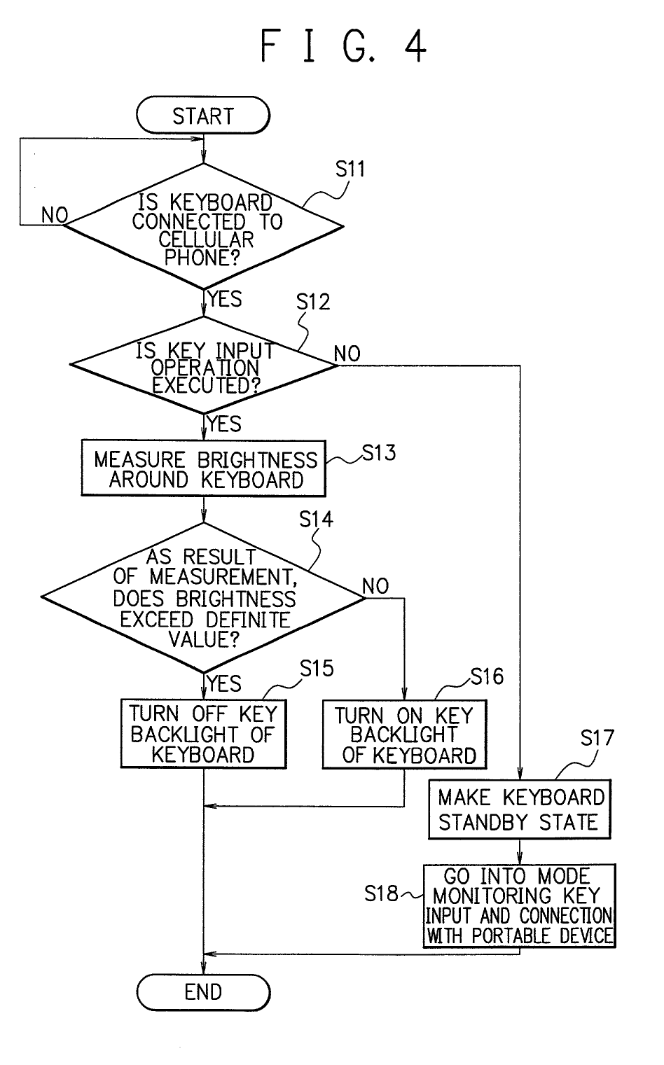

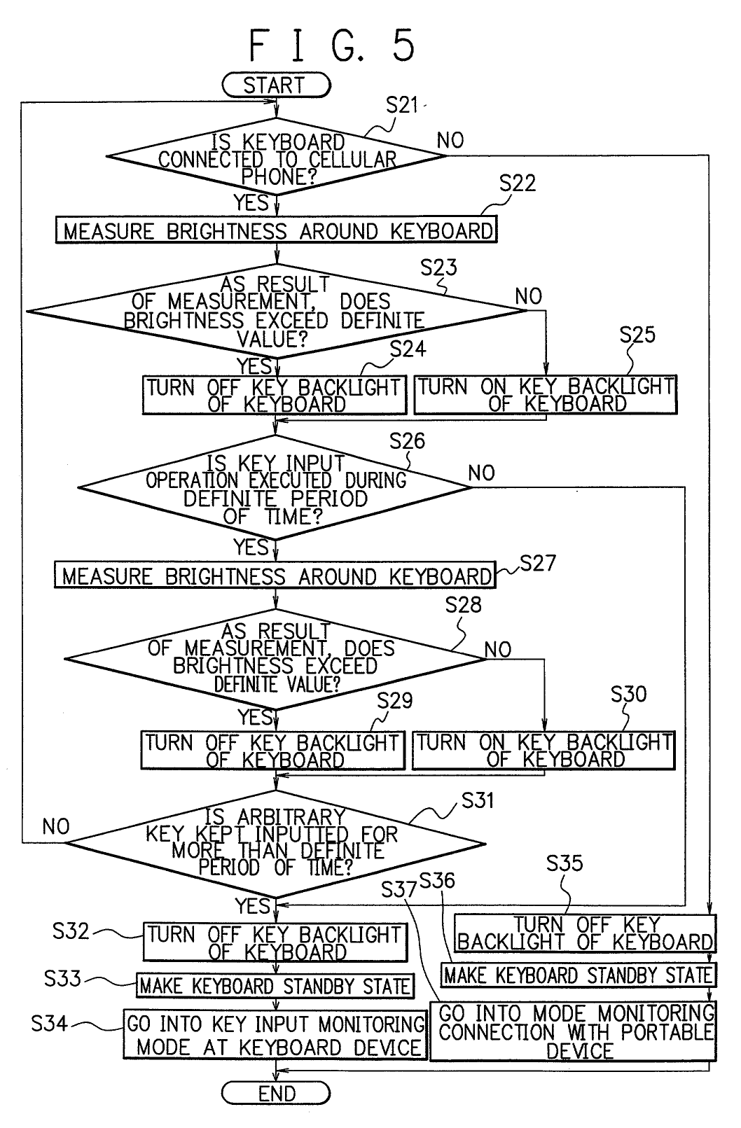

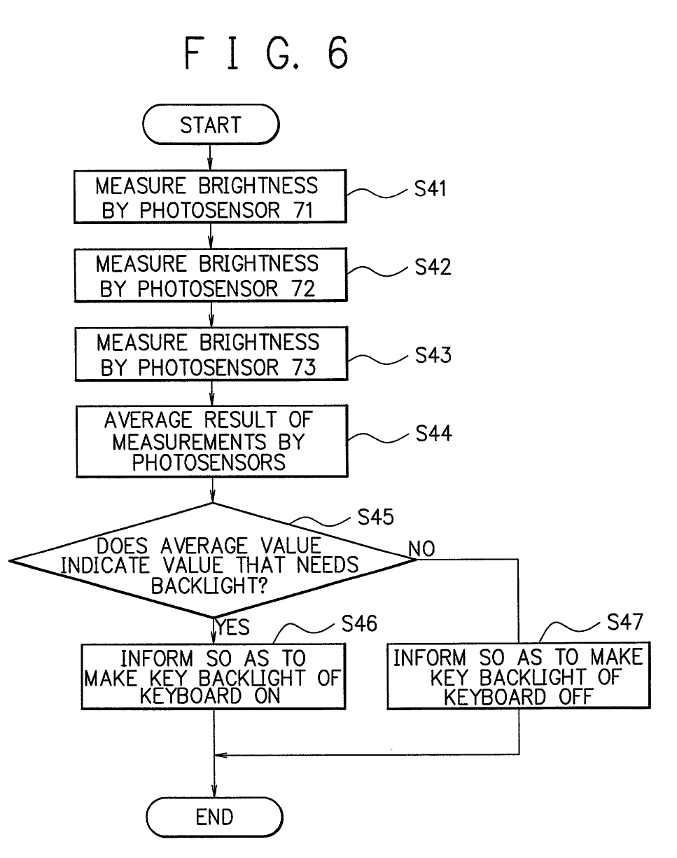

FIG. 1 is a diagram showing a configuration of a keyboard device. FIG. 2A is a conceptual diagram showing an example of a layout of photosensors. FIG. 2B is a perspective diagram viewed obliquely from below a keyboard housing showing a section of a photosensor set in the vicinity of the center of the keyboard housing. FIG. 2C is a perspective diagram viewed obliquely from above the keyboard housing showing the section of the photosensor set in the vicinity of the center of the keyboard housing. FIG. 3 is a flowchart showing a connection state monitoring operation at the keyboard. FIG. 4 is a flowchart showing a key input (keystroke) monitoring operation in a connected state at the keyboard. FIG. 5 is a flowchart showing a key input monitoring operation in the connected state at the keyboard. FIG. 6 is a flowchart showing an operation of measuring brightness at the keyboard.

As shown in FIG. 1, the keyboard device applied to this embodiment comprises a key operation section (or user operation section) 1, LED (light emitting diode) display section 2, key backlight 3, communication control section (or portable device connection area) 4, control section 5, timer 6, and a photosensor 7.

FIG. 2A shows an example of a detail layout of the photosensor 7. FIGS. 2B and 2C are perspective diagrams viewed obliquely from below and above a keyboard housing showing a section of a photosensor set in the vicinity of the center of the keyboard housing, respectively. The photosensor 7 comprises photosensors 71, 72 and 73. The photosensor 71 is set in the vicinity of the upper center of the keyboard housing. As shown in FIGS. 2B and 2C, the photosensor 71 is set in a concave section formed in the vicinity of nearly the center of the keyboard housing. The photosensor 72 is set at the head of the LED. The photosensor 73 is set at a place symmetrical to the photosensor 72. Incidentally, the two elliptic sections by the side of the photosensors 72 and 73 shown in FIG. 2A are fingerholds that are used when a user carries the keyboard device by hand. As shown in FIG. 2A, the two photosensors 72 and 73 are set in the vicinity of the fingerholds.

The keyboard device having the above-described configuration is used, for example, by connecting with a prescribed cellular phone. The communication control section 4 transmits a key code corresponding to each of keys printed on the keyboard from the keyboard device, and thereby, character input and a key operation through a cellular phone are realized.

Next, an example will be given of a backlight controlling operation in the keyboard device referring to FIGS. 3, 4, 5 and 6.

As shown in FIG. 3, as a first step, it is judged whether or not the keyboard device is connected to the cellular phone through the communication control section 4 (Steps S1 and S2). When the keyboard device is connected to the cellular phone (Step S2/YES), the keyboard device goes into an active state (Step S5). After that, the LED in the LED display section 2 is lit up, which indicates that the power is on and the keyboard device is in the active state (Step S6).

On the other hand, when the keyboard device is not connected to the cellular phone (Step S2/NO), the keyboard device goes into a standby state (Step S3). After that, the keyboard device goes into a connection monitoring state without lighting up the LED (Step S4).

Next as a second step, as shown in FIG. 4, keeping the connection between the cellular phone and the keyboard device (Step S11), a key input (keystroke) is monitored, namely, it is checked out whether or not a key input is executed (Step S12). When a key input is executed (Step S12/Yes), brightness around a place where the keyboard is used is measured (Step S13).

As a result of the measurement, when it is possible to get brightness exceeding a definite value, (Step S14/YES), the key backlight in the keyboard is turned off (Step S15). On the other hand, when it is impossible to get brightness exceeding a definite value (Step S14/NO), the key backlight in the keyboard is turned on (Step S16).

Besides, when the cellular phone (or portable device) and the keyboard device are left untouched keeping the connected state therebetween, the keyboard device goes into the standby state (Step S17), and goes into a mode monitoring a key input and the connection with the portable device (Step S18).

Referring to FIG. 5, next, an explanation will be given of an operation when the keyboard device is used as usual and when one arbitrary key is kept pressed down in the connected state between the cellular phone and the keyboard device.

In the case of putting the cellular phone and the keyboard device in a bag etc. keeping the connected state therebetween, it is monitored whether or not one arbitrary key is kept inputted for more than a definite period of time (Step S31). When any arbitrary key is not kept inputted for more than a definite period of time, it is judged that a user is operating the keyboard as usual. Then, the connection therebetween and a key input are monitored keeping the active state. On the other hand, when one arbitrary key is kept inputted for more than a definite period of time, the backlight is turned off (Step S32). Then, the keyboard goes into the standby state (Step S33). After that, the LED of the LED display section 2 is turned off, and the keyboard device goes into the key input monitoring mode (Ste S34).

Referring now to FIG. 6, an example of a brightness measuring operation will be explained. The brightness is measured by using the three photosensors 71, 72 and 73 as shown in FIG. 2A.

First, using the photosensor 71, the brightness at the central part and the side surface of the upper part of the housing is measured (Step S41). Next, by using the photosensor 72, the brightness in front of the housing at some distance from the fingerholds is measured (Step S42). Lastly, by using the photosensor 73, the brightness in front of the housing at some distance from the fingerholds is measured (Step S43).

After finishing measuring process, the values measured by the photosensors 71, 72 and 73, respectively, are aggregated. Then, the average value of the measured values is calculated (Step S44). On the basis of the calculated average value, it is judged whether or not lighting of the backlight is needed (Step S45). When it is needed (Step S45/YES), it is informed that the backlight should be turned on (Step S46). On the other hand, when it is not needed (Step S45/NO), it is informed that the backlight should be turned off (Step S47).

Incidentally, the brightness may be represented by a lux value that indicates the illuminance. Further, it is also possible to substitute the illuminance with an electrical signal. Besides, by using the plurality of photosensors, it is possible to prevent malfunctions caused by changes of brightness arising, for example, from inclining the keyboard in the act of using.

The effect of the present invention is as follows.

1. It is possible to operate the keyboard in the dark in drawing up such as e-mail.

2. The backlight is turned on and off according to brightness around the keyboard. Thereby, it is possible to reduce power consumption when the keyboard is driven by batteries.

3. By controlling the backlight dynamically, the available time of the keyboard gets longer when the keyboard is driven by batteries.

4. By using the plurality of photosensors, it is possible to reduce an amount of changes of brightness caused by inclining the device in the act of using and prevent malfunctions.

Next, a modified example will be given of the embodiment. The present invention can be applied to a compact e-mail terminal and a compact portable PC with a color or monochrome LCD (liquid crystal display), whose backlight at the part of the LCD is dark. Thereby, it is possible to enhance operationality in the dark making the keys emit light by the key backlight. Besides, it is possible to turn on and off the backlight and control the strength and weakness thereof according to brightness measured by the photosensors even if the keyboard device is driven by batteries. Therefore, the power consumption is reduced, and it is possible to extend the available time of the keyboard device much longer.

As set forth hereinabove, there is provided a compact and lightweight keyboard device that can be connected to a portable terminal such as a cellular phone. The keyboard device comprises a photosensor function and a backlight control function. The photosensor measures brightness around the keyboard in the act of operating the keyboard. On the basis of the result of the measurement, the backlight control function controls lighting on and off, and strength and weakness of illuminance of the backlight in the keyboard.

Consequentially, it becomes possible to use the keyboard device regardless of a bright or dark place by mounting the backlight and the photosensors in the keyboard device, measuring brightness around the keyboard in the act of operating the keyboard, and controlling the lighting on and off and the strength and weakness of the backlight on the basis of the measurement.

Besides, according to changes of brightness of the environment, the key backlight is turned on and off and the strength and weakness thereof is controlled. Thereby, it is possible to hold down the power consumption of the backlight when the keyboard device is driven by batteries. In addition, it is possible to prevent substantial increase of average power consumption in the whole of the keyboard device. Further, it is possible to prevent reduction of the available time of the keyboard device caused by being driven by batteries.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A keyboard device comprising:
a key backlight; and
a photosensor, wherein:
the photosensor measures brightness around a place where a keyboard is used; and
the photosensor controls a lighting operation of the key backlight in accordance with a measured value of the brightness measured by the photosensor.

2. A keyboard device comprising:
a key backlight; and
a photosensor measuring brightness around a place where a keyboard is used and controlling a lighting operation of the key backlight in accordance with a measured value of the brightness measured by the photosensor, wherein:
the photosensor comprises at least two pieces thereof and
at least one of the photosensors is set in the vicinity of a fingerhold section on the keyboard.

3. A keyboard device comprising:
a key backlight;
a photosensor; and
a control section, wherein:
the photosensor measures brightness around a place where a keyboard is used;
the photosensor controls a lighting operation of the key backlight in accordance with a measured value of the brightness measured by the photosensor; and
the control section controls operations in the keyboard device.

4. A keyboard device comprising:
a key backlight;
a control section; and
a photosensor measuring brightness around a place where a keyboard is used and controlling a lighting operation of the key backlight in accordance with a measured value of the brightness measured by the photosensor, wherein:
the control section controls operations in the keyboard device;
the photosensor comprises at least two pieces thereof; and
at least one of the photosensors is set in the vicinity of a fingerhold section on the keyboard.

5. The keyboard device as claimed in claim 1, further comprising:
a key operation section; and
a communication control section informing that a key is inputted, wherein:
the keyboard device is intended for a portable terminal.

6. The keyboard device as claimed in claim 2, further comprising:
a key operation section; and
a communication control section informing that a key is inputted, wherein:
the keyboard device is intended for a portable terminal.

7. The keyboard device as claimed in claim 3, further comprising:
a key operation section; and
a communication control section informing that a key is inputted, wherein:
the keyboard device is intended for a portable terminal.

8. The keyboard device as claimed in claim 4, further comprising:
a key operation section; and
a communication control section informing that a key is inputted, wherein:
the keyboard device is intended for a portable terminal.

9. The keyboard device as claimed in claim 1, further comprising:
a key operation section;
a communication control section informing that a key is inputted; and
a timer measuring an interval of latency from a last time a key is inputted until a new key is inputted, wherein:
the keyboard device is intended for a portable terminal.

10. The keyboard device as claimed in claim 2, further comprising:
a key operation section;
a communication control section informing that a key is inputted; and
a timer measuring an interval of latency from a last time a key is inputted until a new key is inputted, wherein:
the keyboard device is intended for a portable terminal.

11. The keyboard device as claimed in claim 3, further comprising:
a key operation section;
a communication control section informing that a key is inputted; and
a timer measuring an interval of latency from a last time a key is inputted until a new key is inputted, wherein:
the keyboard device is intended for a portable terminal.

12. The keyboard device as claimed in claim 4, further comprising:
a key operation section;
a communication control section informing that a key is inputted; and
a timer measuring an interval of latency from a last time a key is inputted until a new key is inputted, wherein:
the keyboard device is intended for a portable terminal.

13. The keyboard device as claimed in claim 1, further comprising:
a key operation section;
a communication control section informing that a key is inputted; and
a function state display section indicating that power is in an on-state and that the keyboard device is in an active state, wherein:
the keyboard device is intended for a portable terminal.

14. The keyboard device as claimed in claim 2, further comprising:
a key operation section;
a communication control section informing that a key is inputted; and
a function state display section indicating that power is in an on-state and that the keyboard device is in an active state, wherein:
the keyboard device is intended for a portable terminal.

15. The keyboard device as claimed in claim 3, further comprising:
a key operation section;
a communication control section informing that a key is inputted; and
a function state display section indicating that power is in an on-state and that the keyboard device is in an active state, wherein:
the keyboard device is intended for a portable terminal.

16. The keyboard device as claimed in claim 4, further comprising:
a key operation section;
a communication control section informing that a key is inputted; and
a function state display section indicating that power is in an on-state and that the keyboard device is in an active state, wherein:
the keyboard device is intended for a portable terminal.

17. The keyboard device as claimed in claim 1, further comprising:
a timer measuring an interval of latency from a last time a key is inputted until a new key is inputted; and
a function state display section indicating that power is in an on-state and that the keyboard device is in an active state.

18. The keyboard device as claimed in claim 2, further comprising:
a timer measuring an interval of latency from a last time a key is inputted until a new key is inputted; and
a function state display section indicating that power is in an on-state and that the keyboard device is in an active state.

19. The keyboard device as claimed in claim 3, further comprising:
a timer measuring an interval of latency from a last time a key is inputted until a new key is inputted; and
a function state display section indicating that power is in an on-state and that the keyboard device is in an active state.

20. The keyboard device as claimed in claim 4, further comprising:
a timer measuring an interval of latency from a last time a key is inputted until a new key is inputted; and
a function state display section indicating that power is in an on-state and that the keyboard device is in an active state.

21. The keyboard device as claimed in claim 1, further comprising:
a key operation section;
a communication control section informing that a key is inputted;
a timer measuring an interval of latency from a last time a key is inputted until a new key is inputted; and
a function state display section indicating that power is in an on-state and that the keyboard device is in an active state, wherein:
the keyboard device is intended for a portable terminal.

22. The keyboard device as claimed in claim 2, further comprising:
a key operation section;
a communication control section informing that a key is inputted;
a timer measuring an interval of latency from a last time a key is inputted until a new key is inputted; and
a function state display section indicating that power is in an on-state and that the keyboard device is in an active state, wherein:
the keyboard device is intended for a portable terminal.

23. The keyboard device as claimed in claim 3, further comprising:
a key operation section;
a communication control section informing that a key is inputted;
a timer measuring an interval of latency from a last time a key is inputted until a new key is inputted; and
a function state display section indicating that power is in an on-state and that the keyboard device is in an active state, wherein:
the keyboard device is intended for a portable terminal.

24. The keyboard device as claimed in claim 4, further comprising:
a key operation section;
a communication control section informing that a key is inputted;
a timer measuring an interval of latency from a last time a key is inputted until a new key is inputted; and
a function state display section indicating that power is in an on-state and that the keyboard device is in an active state, wherein:
the keyboard device is intended for a portable terminal.

25. The keyboard device as claimed in claim 1, wherein the lighting operation of the key backlight is controlled on the basis of an average value of measurements by the photosensors.

26. The keyboard device as claimed in claim 2, wherein the lighting operation of the key backlight is controlled on the basis of an average value of measurements by the photosensors.

27. The keyboard device as claimed in claim 3, wherein the lighting operation of the key backlight is controlled on the basis of an average value of measurements by the photosensors.

28. The keyboard device as claimed in claim 4, wherein the lighting operation of the key backlight is controlled on the basis of an average value of measurements by the photosensors.
